(19) United States
(12) Patent Application Publication
(10) Pub. No.: US 2026/0012679 A1
(43) Pub. Date: Jan. 8, 2026

(54) HIGH FREQUENCY CONTENT MANAGEMENT METHODS AND SYSTEM

(71) Applicant: BLUMEx Inc., Markham (CA)

(72) Inventor: Ravi Ravindran, Markham (CA)

(73) Assignee: BLUMEx Inc., Markham (CA)

(21) Appl. No.: 19/261,821

(22) Filed: Jul. 7, 2025

Related U.S. Application Data
(60) Provisional application No. 63/667,968, filed on Jul. 5, 2024.

(51) Int. Cl. H04N 21/431; H04N 21/2743; H04N 21/442; H04N 21/845

(52) U.S. Cl. CPC H04N 21/4318; H04N 21/2743; H04N 21/4316; H04N 21/44204; H04N 21/8456

(57) ABSTRACT

The various embodiments herein provide a system and method for generating high frequency content from long-form media. The system automates the transformation of long-form audio or video content into multiple shorter, engaging formats using advanced AI-driven tools. The system comprises modules for content ingestion, preprocessing, segmentation, editing, repurposing, distribution, and analytics. It begins by ingesting and preprocessing content through noise reduction, normalization, and transcription. The content is then segmented, edited, and repurposed into various formats using natural language processing and template-based generation. AI-driven enhancements ensure contextual editing and summarization, while user customization allows for tailored content. The repurposed content is distributed across multiple platforms, and performance data is collected and analyzed for continuous optimization. This integrated approach enhances efficiency, reduces manual labor, and maintains high-quality output, providing a comprehensive solution for content creators.

### CROSS-REFERENCE TO RELATED APPLICATIONS

The embodiments herein claim the priority of the U.S. Provisional Patent Application filed on Jul. 5, 2024, with the No. 63/667,968 and titled, “HIGH FREQUENCY CONTENT MANAGEMENT METHODS AND SYSTEM”, the contents of which are incorporated herein by the way of reference.

### BACKGROUND

### Description of the Related Art

The embodiments herein are generally related to audio and visual media. The embodiments herein are particularly related to automated content transformation process of audio-visual media. The embodiments herein are more particularly related to a system and method for generating high frequency content from long-form media.

### Description of the Related Art

Current methods for content transformation often involve manual processes where human editors listen to or watch the entire long-form content, identify key segments, and create shorter clips, summaries, and social media posts. These traditional methods are time-consuming, resource-intensive, and can result in inconsistent quality due to the variability in editors' skills and workloads. Basic automated tools exist, offering features like transcription services, basic editing functionalities, and template-based summarization. However, these tools suffer from limited contextual understanding, minimal user customization, and fragmented workflows, leading to inefficiencies and increased complexity.

Recent advancements in machine learning and natural language processing have led to more sophisticated tools for content transformation. Advanced speech-to-text technologies, automated content summarization, and AI-driven video editing have improved the landscape. Despite these advancements, existing solutions are either costly, complex to integrate, or limited in providing a comprehensive end-to-end solution.

Therefore, there exists a need for a system and method for generating high frequency content from long-form media that seamlessly combines advanced AI capabilities with user customization options.

The abovementioned shortcomings, disadvantages and problems are addressed herein, which will be understood by reading and studying the following specification.

### OBJECT OF THE EMBODIMENTS HEREIN

The primary object of the embodiments herein is to provide a system and method to generate high frequency content from long-form media.

Another object of the embodiments herein is to provide a system and method for automating the transformation of long-form content into multiple shorter formats using advanced AI-driven tools.

Yet another object of the embodiments herein is to enable contextual editing and summarization through the use of AI algorithms.

Yet another object of the embodiments herein is to allow user intervention and customization at various stages of the content transformation process.

Yet another object of the embodiments herein is to enhance the efficiency of content processing and reduce the reliance on manual labor.

Yet another object of the embodiments herein is to maintain high-quality output across all repurposed content formats.

Yet another object of the embodiments herein is to ensure versatility by converting long-form content into diverse formats suitable for different platforms.

Yet another object of the embodiments herein is to incorporate performance analytics to provide insights for continuous content optimization.

Yet another object of the embodiments herein is to reduce operational costs while maintaining high-quality content transformation.

Yet another object of the embodiments herein is to provide a comprehensive solution that addresses the limitations of current content transformation technologies.

These and other objects and advantages of the embodiments herein will become readily apparent from the following detailed description taken in conjunction with the accompanying drawings.

### SUMMARY

The following details present a simplified summary of the embodiments herein to provide a basic understanding of the several aspects of the embodiments herein. This summary is not an extensive overview of the embodiments herein. It is not intended to identify key/critical elements of the embodiments herein or to delineate the scope of the embodiments herein. Its sole purpose is to present the concepts of the embodiments herein in a simplified form as a prelude to the more detailed description that is presented later.

The other objects and advantages of the embodiments herein will become readily apparent from the following description taken in conjunction with the accompanying drawings.

The various embodiments herein provide a system and method for generating high frequency content from long-form media.

According to one embodiment herein, a system is provided for generating high frequency content from long-form media. The system comprises Content Ingestion Module that accepts long-form content from a plurality of sources and formats; Preprocessing Module that prepares content through noise reduction, normalization, and transcription; Segmentation Module that divides content into meaningful segments using advanced algorithms; Editing Module that refines and enhances content segments with effects and transitions; Repurposing Module that transforms segments into shorter formats using NLP and templates; AI Module that enhances content processing with machine learning models; User Input Module that allows user customization and approval of content segments; Content Distribution Module that distributes content across multiple platforms and channels; Analytics and Feedback Module that collects and analyzes performance data for continuous optimization.

According to one embodiment herein, a method is provided for generating high frequency content from long-form media. The method begins with Content Ingestion that accepts long-form content from a plurality of sources including podcasts, webinar recordings, and live streams to ingest raw media files in a plurality of media formats; Preprocessing of input media that cleans and transcribes content; Segmentation that divides content into smaller meaningful segments using algorithmic analysis to identify logical breaks, speaker changes and natural pauses; Editing of segmented media wherein each segment is refined and enhanced using visual and auditory effects while maintaining the quality of the media; Repurposing the segments into shorter formats using a plurality of techniques including template based generation and NLP (Natural Language Processing) based techniques to generate relevant and engaging content tailored to a plurality of platforms and audience preferences; AI Enhancement for contextual editing, summarization and keyword extraction while maintaining coherence and relevance through content optimization; User Customization that allows user intervention, customization and approval of final output; Distribution of repurposed contents across a plurality of platforms using a plurality of methods including automated publishing and by API integration; and Data analysis of performance data for content improvement and optimization.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates the overall architecture of the system for generating high frequency content from long-form media, according to one embodiment herein.

FIG. 2 illustrates a method for generating high frequency content from long-form media, according to one embodiment herein.

Although the specific features of the embodiments herein are shown in some drawings and not in others. This is done for convenience only as each feature may be combined with any or all of the other features in accordance with the embodiment herein.

### DETAILED DESCRIPTION OF THE EMBODIMENTS HEREIN

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that other changes may be made without departing from the scope of the embodiments. The following detailed description is therefore not to be taken in a limiting sense.

The various embodiments herein provide a system and method for generating high frequency content from long-form media.

According to one embodiment herein, a system is provided for generating high frequency content from long-form media. The system comprises: a Content Ingestion Module; a Preprocessing Module; a Segmentation Module; an Editing Module; a Repurposing Module; an AI Module; a User Input Module; a Content Distribution Module; and an Analytics and Feedback Module.

According to one embodiment herein, the Content Ingestion Module accepts long-form media content from a plurality of sources including podcasts, webinars, and live streams, in a plurality of formats and integrates with a plurality of content platforms. The ingested content is then passed on to the Preprocessing Module.

According to one embodiment herein, the Preprocessing Module prepares the ingested content by performing essential tasks including noise reduction, normalization, and transcription including audio-video to text conversion. The module ensures that the content is clean and ready for further segmentation. It uses advanced algorithms to improve the quality of the audio or video and generates accurate transcriptions, essential for subsequent processing stages.

According to one embodiment herein, the Segmentation Module divides the preprocessed content into smaller meaningful segments using sophisticated algorithms to identify logical breaks including topic changes, speaker changes, or natural pauses, leveraging timestamps and speech-to-text analysis. This segmentation is essential for creating concise and coherent shorter pieces of content.

According to one embodiment herein, the Editing Module refines and enhances the segmented content. It applies automated or semi-automated tools to edit the video and audio segments, adding effects, transitions, and other enhancements ensuring high-quality output. This module further prepares each segment for repurposing.

According to one embodiment herein, the AI Module uses advanced machine learning and deep learning models for editing, summarization, keyword extraction, and content optimization. It provides contextual understanding of the content, ensuring that the repurposed pieces maintain coherence and relevance.

According to one embodiment herein, the User Interface Module allows users to input preferences, make manual edits, and approve content segments, enabling flexibility and customization capabilities. It is configured with interfaces for user intervention at various stages, ensuring that the final output meets specific needs and standards.

According to one embodiment herein, the Content Distribution Module handles the distribution of repurposed content to a plurality of platforms and channels. It integrates with social media APIs, podcast platforms, video-sharing websites, and other content delivery networks to publish the content, ensuring that the repurposed content reaches a wide audience efficiently.

According to one embodiment herein, a method is provided for generating high frequency content from long-form media. The method begins with Content Ingestion that accepts long-form content from a plurality of sources including podcasts, webinar recordings, and live streams to ingest raw media files in a plurality of media formats; Preprocessing of input media that cleans and transcribes content; Segmentation that divides content into smaller meaningful segments using algorithmic analysis to identify logical breaks, speaker changes and natural pauses; Editing of segmented media wherein each segment is refined and enhanced using visual and auditory effects while maintaining the quality of the media; Repurposing the segments into shorter formats using a plurality of techniques including template based generation and NLP (Natural Language Processing) based techniques to generate relevant and engaging content tailored to a plurality of platforms and audience preferences; AI Enhancement for contextual editing, summarization and keyword extraction while maintaining coherence and relevance through content optimization; User Customization that allows user intervention, customization and approval of final output; Distribution of repurposed contents across a plurality of platforms using a plurality of methods including automated publishing and by API integration; and Data analysis of performance data for content improvement and optimization.

According to one embodiment herein, Pre-processing of input media comprises Noise Reduction wherein noise is the media content including audio and video content is reduced to improve the media clarity; Normalization wherein the audio and visual levels are adjusted to a consistent standard to ensure uniform audio and visual quality; Transcription wherein the words in the audio and video are converted to text using speech-to-text technology for subsequent analysis and processing stages.

According to an embodiment herein, a system for generating high-frequency content from long-form media comprises a content ingestion module that receives long-form media content from a plurality of sources and formats, a preprocessing module that performs noise reduction, normalization, and transcription on the received media content, a segmentation module that divides the preprocessed media content into meaningful segments based on logical breaks, speaker changes, and natural pauses, an editing module that refines each segmented media portion by applying visual and auditory enhancements including transitions and effects, a repurposing module that transforms the refined segments into shorter-form content using template-based and natural language processing (NLP) techniques, an artificial intelligence (AI) module that performs contextual editing, summarization, keyword extraction, and optimization of the transformed segments using machine learning models, a user interface module that receives user preferences, edits, and approvals with respect to the transformed segments, a content distribution module that publishes the repurposed content across a plurality of digital platforms and content delivery networks, and an analytics and feedback module that collects, analyzes, and reports performance metrics of the published content for iterative content optimization.

According to an embodiment herein, the content ingestion module receives media files from live streams, podcasts, and webinar recordings. The preprocessing module includes a noise reduction submodule that filters background noise, a normalization submodule that adjusts audio and video levels to standardized thresholds, and a transcription submodule that converts audio content to text using speech-to-text technology. The segmentation module uses speech-to-text analysis and timestamp correlation to identify segment boundaries based on topic transitions, speaker identity, and natural pauses. The editing module applies predefined or user-selected visual effects, transitions, overlays, and audio enhancements to each segment to improve quality.

According to an embodiment herein, the repurposing module generates short-form content tailored for platform-specific constraints including video duration limits, aspect ratios, and content styles. The AI module includes a machine learning model trained on domain-specific datasets to provide context-aware summarization and optimization of the repurposed segments. The user interface module offers graphical tools for manual editing of segments, adjustment of content metadata, and real-time preview of the transformed media. The content distribution module interfaces with platform-specific application programming interfaces (APIs) for automated publishing and scheduling. The analytics and feedback module computes performance indicators including view count, click-through rate, watch time, and user engagement for each repurposed content segment.

According to an embodiment herein, a method for generating high-frequency content from long-form media comprises the steps of ingesting long-form media content from a plurality of sources and formats, preprocessing the ingested media content by performing noise reduction, normalization, and transcription, segmenting the preprocessed media content into meaningful segments based on logical breaks, speaker changes, and natural pauses, editing the segmented media content by applying visual and auditory enhancements to each segment, repurposing the edited segments into shorter-form content using template-based and NLP-based transformation techniques, enhancing the repurposed segments using artificial intelligence for contextual editing, summarization, keyword extraction, and optimization, receiving user input including customization, manual edits, and approval of the final output, distributing the approved and repurposed content across a plurality of digital platforms, and analyzing content performance data to generate feedback for iterative optimization.

According to an embodiment herein, the step of ingesting includes receiving media files from live-stream platforms, podcast directories, and recorded webinars using the content ingestion module. The step of preprocessing includes reducing background noise, normalizing audio levels to a standard decibel range, and converting audio speech to textual transcripts using the preprocessing module. The step of segmenting includes identifying segment boundaries using timestamps, speech-to-text correlation, and speaker diarization through the segmentation module. The step of editing includes adding transitions, overlay graphics, and audio effects to the segmented media using the editing module.

According to an embodiment herein, the step of repurposing includes selecting appropriate content templates and generating platform-optimized short-form content using the repurposing module. The step of enhancing includes applying deep learning-based summarization models, context analyzers, and keyword extraction algorithms via the AI module. The step of receiving user input includes enabling users to modify metadata, rearrange content sequence, and approve final versions using the user interface module. The step of distributing includes publishing the final content through APIs linked to social media, podcast platforms, and video hosting services via the content distribution module. The step of analyzing includes computing engagement metrics and generating performance reports using the analytics and feedback module.

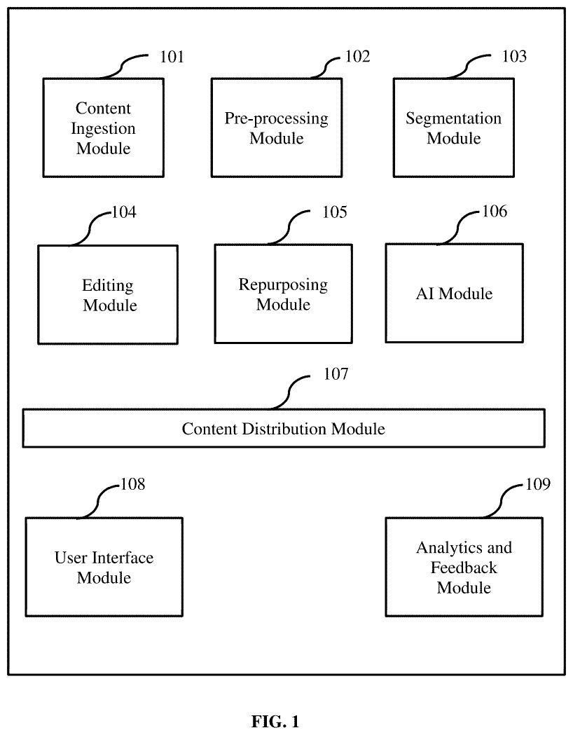

FIG. 1 illustrates the overall architecture of the system for generating high frequency content from long-form media, according to one embodiment herein. The system comprises Content ingestion module 101, Pre-processing module 102, Segmentation Module 103, Editing Module 104, Repurposing Module 105, AI Module 106, Content Distribution Module 107, User Interface Module 108, and Analytics and Feedback Module 109.

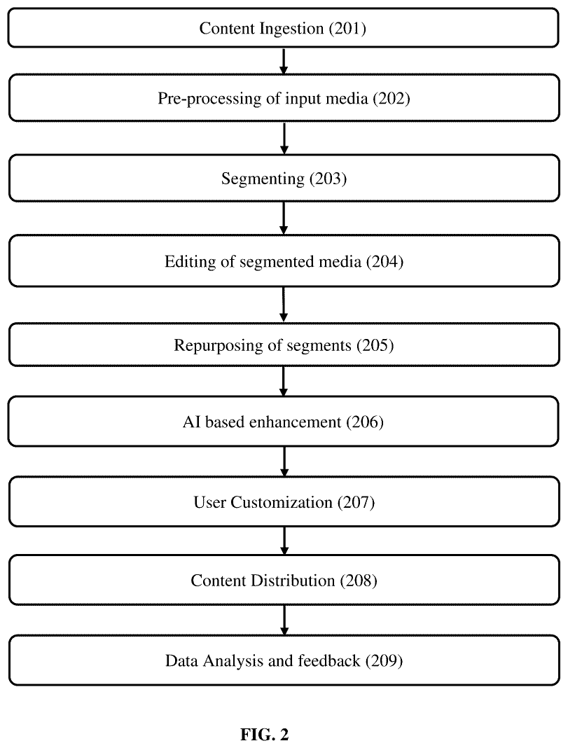

FIG. 2 illustrates a method for generating high frequency content from long-form media, according to one embodiment herein. The method comprises: Content Ingestion (201), Pre-processing of input media (202), Segmenting (203), Editing of segmented media (204), Repurposing of segments (205), AI based enhancements (206), User customization (207), Content Distribution (208), and Data Analysis and feedback (209).

The various embodiments herein provide a system and method for generating high frequency content from long-form media offering several distinct advantages over existing content transformation technologies, offering a robust, efficient, and high-quality solution. The system enhances efficiency by automating the entire content transformation process, significantly reducing time and effort. Advanced AI-driven tools ensure high-quality output across all formats, maintaining coherence and relevance. User customization options allow for tailored media contents. The system's versatility enables the conversion of long-form content into diverse formats, reaching different audiences effectively. Integrated performance analytics provide valuable insights for continuous improvement. By automating labor-intensive tasks, the system reduces operational costs while ensuring consistent quality. Advanced preprocessing techniques enhance content quality, and the system's scalability makes it suitable for various content creation needs. Overall, the system addresses the limitations of current methods and tools, providing a comprehensive solution for content creators.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

It is also to be understood that the following claims are intended to cover all of the generic and specific features of the embodiments described herein and all the statements of the scope of the embodiments which as a matter of language might be said to fall there between.

What is claimed is:

1. A system for generating high-frequency content from long-form media, comprising:
a content ingestion module configured to receive long-form media content from a plurality of sources and formats;
a preprocessing module communicatively coupled to the content ingestion module and configured to perform noise reduction, normalization, and transcription on the received media content;
a segmentation module communicatively coupled to the preprocessing module and configured to divide the preprocessed media content into meaningful segments based on logical breaks, speaker changes, and natural pauses;
an editing module communicatively coupled to the segmentation module and configured to refine each segmented media portion by applying visual and auditory enhancements including transitions and effects;
a repurposing module communicatively coupled to the editing module and configured to transform the refined segments into shorter-form content using template-based and natural language processing (NLP) techniques;
an artificial intelligence (AI) module communicatively coupled to the repurposing module and configured to perform contextual editing, summarization, keyword extraction, and optimization of the transformed segments using machine learning models;
a user interface module configured to receive user preferences, edits, and approvals with respect to the transformed segments;
a content distribution module configured to publish the repurposed content across a plurality of digital platforms and content delivery networks; and,
an analytics and feedback module configured to collect, analyze, and report performance metrics of the published content for iterative content optimization.

2. The system according to claim 1, wherein the content ingestion module is further configured to receive media files from live streams, podcasts, and webinar recordings.

3. The system according to claim 1, wherein the preprocessing module comprises a noise reduction submodule that filters background noise, a normalization submodule that adjusts audio and video levels to standardized thresholds, and a transcription submodule that converts audio content to text using speech-to-text technology.

4. The system according to claim 1, wherein the segmentation module utilizes speech-to-text analysis and timestamp correlation to identify segment boundaries based on topic transitions, speaker identity, and natural pauses.

5. The system according to claim 1, wherein the editing module is configured to apply predefined or user-selected visual effects, transitions, overlays, and audio enhancements to each segment.

6. The system according to claim 1, wherein the repurposing module is configured to generate short-form content tailored for platform-specific constraints including video duration limits, aspect ratios, and content styles.

7. The system according to claim 1, wherein the AI module comprises a machine learning model trained on domain-specific datasets to ensure context-aware summarization and optimization of the repurposed segments.

8. The system according to claim 1, wherein the user interface module provides graphical tools enabling manual editing of segments, adjustment of content metadata, and real-time preview of transformed media.

9. The system according to claim 1, wherein the content distribution module interfaces with platform-specific application programming interfaces (APIs) for automated publishing and scheduling.

10. The system according to claim 1, wherein the analytics and feedback module computes performance indicators including view count, click-through rate, watch time, and user engagement for each repurposed content segment.

11. A method for generating high-frequency content from long-form media, comprising:
ingesting long-form media content from a plurality of sources and formats;
preprocessing the ingested media content by performing noise reduction, normalization, and transcription;
segmenting the preprocessed media content into meaningful segments based on logical breaks, speaker changes, and natural pauses;
editing the segmented media content by applying visual and auditory enhancements to each segment;
repurposing the edited segments into shorter-form content using template-based and NLP-based transformation techniques;
enhancing the repurposed segments using artificial intelligence for contextual editing, summarization, keyword extraction, and optimization;
receiving user input including customization, manual edits, and approval of the final output;
distributing the approved and repurposed content across a plurality of digital platforms; and,
analyzing content performance data to generate feedback for iterative optimization.

12. The method according to claim 11, wherein the step of ingesting comprises receiving media files from live-stream platforms, podcast directories, and recorded webinars using the content ingestion module.

13. The method according to claim 11, wherein the step of preprocessing comprises reducing background noise, normalizing audio levels to a standard decibel range, and converting audio speech to textual transcripts using the preprocessing module.

14. The method according to claim 11, wherein the step of segmenting comprises identifying segment boundaries using timestamps, speech-to-text correlation, and speaker diarization with the segmentation module.

15. The method according to claim 11, wherein the step of editing comprises adding transitions, overlay graphics, and audio effects to the segmented media using the editing module.

16. The method according to claim 11, wherein the step of repurposing comprises selecting appropriate content templates and generating platform-optimized short-form content using the repurposing module.

17. The method according to claim 11, wherein the step of enhancing comprises applying deep learning-based summarization models, context analyzers, and keyword extraction algorithms via the AI module.

18. The method according to claim 11, wherein the step of receiving user input comprises enabling users to modify metadata, rearrange content sequence, and approve final versions using the user interface module.

19. The method according to claim 11, wherein the step of distributing comprises publishing the final content through APIs linked to social media, podcast platforms, and video hosting services via the content distribution module.

20. The method according to claim 11, wherein the step of analyzing comprises computing engagement metrics and generating performance reports using the analytics and feedback module.
